(19) United States
(12) Patent Application Publication
(10) Pub. No.: US 2007/0283446 A1
(43) Pub. Date: Dec. 6, 2007

(54) System and method for secure handling of scanned documents

(75) Inventors: Sameer Yami, Irvine, CA (US); Amir Shahindoust, Laguna Niguel, CA (US); Michael Yeung, Mission Viejo, CA (US); Peter Tran, Garden Grove, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/446,908

(22) Filed: Jun. 5, 2006

(51) Int. Cl. H04L 9/32

(52) U.S. Cl. 726/27

(57) ABSTRACT

A system and method for secure handling of scanned documents is provided. Electronic document data is received by a document processing device and assigned an identifier unique to the document. A user ID or electronic mail address is then received corresponding to the selected output operation. The user ID or address is then transmitted, along with the identifier, to an encryption key generator, which then generates a symmetric encryption key. The encryption key is then returned to the document processing device, whereupon the electronic document data is encrypted and the key is deleted by the document processing device. The encrypted document is then stored or transmitted via electronic mail, in accordance with the selected output operation. Decryption is thereafter accomplished using the document identifier, user ID or email address, and key generator identification data.

### BACKGROUND OF THE INVENTION

The subject application is directed to a system and method for secure handling of scanned documents. In particular, the subject application is directed to a system and method by which an input document is stored or retransmitted securely such that future access to any such document is limited to authorized recipients. Encryption is accomplished through electronic keys that are associated with each input document.

Multi-functional peripheral devices or other document processing devices allow a user to generate an electronic document from a tangible input medium. This electronic document may then be stored, printed, or transmitted to at least one selected recipient, such as an electronic mail address, remote printer, or facsimile device. Typically the storage and transmission of the electronic document is not secure. As such, any user may access the electronic document or tangible output of another which is a problem, particularly if such electronic document contains sensitive or confidential information.

Some multi-functional peripheral devices provide secure storage of electronic documents and require authentication for a user to access the user's documents. However, a problem often exists in the management of multiple users' access to the same document. In a shared peripheral environment, such as with one or more networked multi-function peripherals, there is no mechanism by which encrypted information can be readily decrypted at any one of a plurality of peripherals. For example, when the user desires to access a document from secure storage via one medium, such as directly from a document server, versus via another medium, such as via electronic mail, the user is required to remember multiple procedures to access the document, leading to user error and frustration.

The subject application overcomes the above-noted problems and provides a system and method for secure handling of scanned documents which routs them securely, in encrypted form, to a targeted destination.

### SUMMARY OF THE INVENTION

In accordance with the subject application, there is provided a system and method for secure handling of scanned documents.

Further, in accordance with the subject application, there is provided a system and method by which an input document is stored or retransmitted securely such that future access to any such document is limited to authorized recipients.

Still further, in accordance with the subject application, there is provided a system and method for secure handing of scanned document using encryption, wherein such encryption is accomplished through electronic keys that are associated with each input document.

Still further, in accordance with the subject application, there is provided a system for the secure handling of scanned documents. The system includes receiving means adapted for receiving electronic document data representative of content of at least one tangible document from an associated scanner and means adapted for assigning document identifier data to each received electronic document. The system also includes a key server, including means adapted for storing key data representative of a plurality of encryption keys, each encryption key being associated with document identifier data corresponding thereto. The key server also includes means adapted for communicating with an associated data network. The system further includes encryption means adapted for encrypting received electronic document data in accordance with at least one encryption key and means adapted for communicating encrypted electronic document data to at least one destination. The system also comprises means adapted for receiving user information from an associated user, wherein the user information includes identification data corresponding to the associated user.

Also included in the system are means adapted for receiving, from the associated user, a document access request directed to at least one selected electronic document, wherein the document access request includes data representative of a desired access to at least one encrypted electronic document. The system further comprises means adapted for communicating user information and document identifier data corresponding to the at least one selected electronic document to the key server. The system further includes testing means for adapted for testing the user information to determine accessibility of the at least one selected electronic document in accordance with the user information and means adapted for selectively decrypting the at least one selected electronic document in accordance with key data corresponding thereto.

Still further, in accordance with the subject application, there is provided a method for secure handling of scanned documents. The method receives electronic document data representative of content of at least one tangible document from an associated scanner and assigns document identifier data to each received electronic document. The method stores key data representative of a plurality of encryption keys in an associated key server, wherein each encryption key is associated with document lo identifier data corresponding thereto. The method further encrypts received electronic document data in accordance with at least one encryption key and communicates encrypted electronic document data to at least one destination. User information is received from an associated user, wherein the user information includes identification data corresponding to the associated user. A document access request directed to at least one selected document is also received from the user, wherein the document access request includes data representative of a desired access to at least one encrypted electronic document. The user information and document identifier data corresponding to the at least one selected electronic document is communicated to the key server. The user information is tested to determine accessibility of the at least one selected electronic document in accordance with the user information and the at least one selected electronic document is selectively decrypted in accordance with key data corresponding thereto.

In the system and method as set forth in the subject application, the electronic document is suitably received via facsimile input, optical character recognition device, or digitizing image scanner. Preferably, the encrypted electronic document is suitably communicated to least one of a data storage and as an electronic mail to at least one selected recipient.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 which is an overall system diagram of the system for secure handling of scanned documents according to the subject application;

FIG. 2 is a flowchart illustrating the method for secure handling of scanned documents from an encryption view according to the subject application; and

FIG. 3 is a flowchart illustrating the method for secure handling of scanned documents from a decryption view according to the subject application.

### DETAILED DESCRIPTION OF THE PREFERRED EMBODIMENT

The subject application is directed a system and method for secure handling of scanned documents. In particular, the subject application is directed to a system and method by which an input document is stored or retransmitted securely such that future access to any such document is limited to authorized recipients. More particularly, the subject application is directed to a system and method for secure handing of scanned documents using encryption, wherein such encryption is accomplished through electronic keys that are associated with each input document. Throughout the detailed description, the use of the term “server”, as will be understood by those skilled in the art, is deemed to include software, hardware, or any suitable combination thereof capable of functioning as a server-side of a client-server relationship. As will further be appreciated by the skilled artisan, one or more components, while termed “server”, are suitably adapted to function as a client of another server, as will be understood in view of the accompanying figures and explanation corresponding thereto.

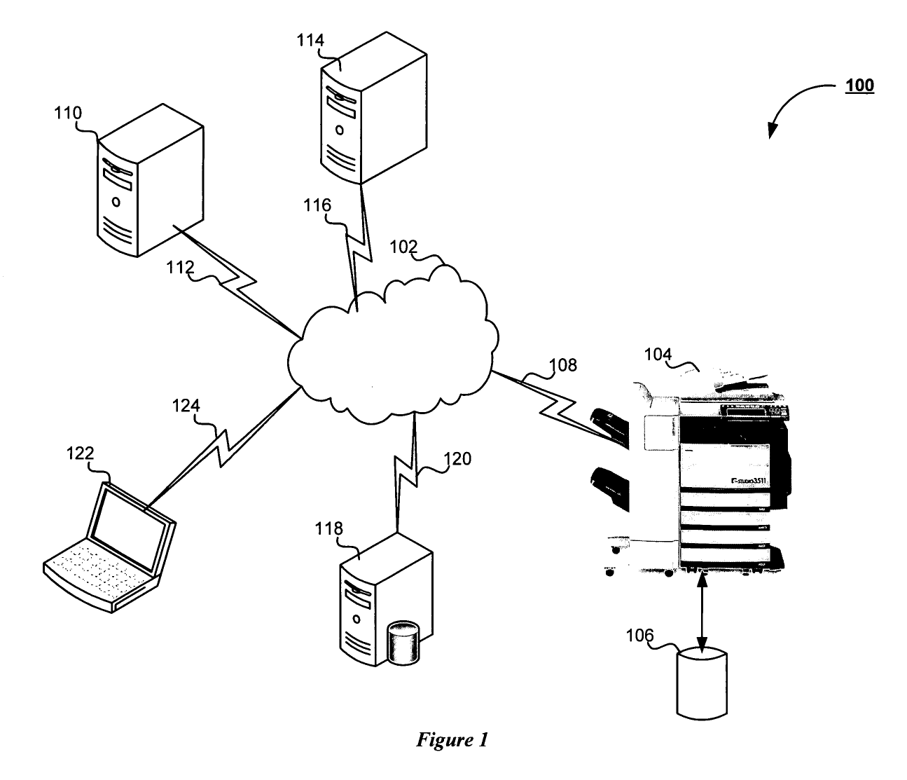

Turning now to FIG. 1, there is shown a diagram illustrating an overall system 100 for secure handling of scanned documents in accordance with the subject application. As depicted in FIG. 1, the system 100 includes a distributed computing environment, represented as a computer network 102. It will be appreciated by those skilled in the art that the computer network 102 is any distributed communications environment known in the art capable of allowing two or more electronic devices to exchange data. The skilled artisan will understand that the computer network 102 is any computer network, known in the art, including for example, and without limitation, a local area network, a wide area network, a personal area network, a virtual network, an intranet, the Internet, or any combination thereof In the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wire-based or wireless data communication mechanisms.

The system 100 further includes at least one document processing device 104, represented as a multifunction peripheral device. It will be understood by those skilled in the art that the document processing device 104 is suitably adapted to provide a variety of document processing services, such as, for example and without limitation, electronic mail, digitizing images, copying, facsimile, document management, printing, optical character recognition, and the like. Suitable commercially available document processing devices include, but are not limited to, the Toshiba e-Studio Series Controller. In one embodiment, the document processing device 104 is suitably equipped to receive a plurality of portable storage media, including without limitation, Firewire drive, USB drive, SD, MMC, XD, Compact Flash, Memory Stick, and the like. In the preferred embodiment of the subject application, the document processing device 104 further includes an associated user-interface, such as a touch-screen interface, LCD display, or the like, via which an associated user is able to interact directly with the document processing device 104. In accordance with the preferred embodiment of the subject application, the document processing device 104 further includes memory, such as mass storage, RAM, or the like, suitably adapted to function as a queue, in which pending document processing jobs and job information are stored. Preferably, the document processing device 104 further includes a data storage device 106, communicatively coupled to the document processing device 104, suitably adapted to provide document storage, user authentication information, and the like. As will be understood by those skilled in the art, the data storage device 106 is any mass storage device known in the art including, for example and without limitation, a hard disk drive, other magnetic storage devices, optical storage devices, flash memory devices, or any combination thereof.

In accordance with one embodiment of the subject application, the document processing device 104 is in data communication with the computer network 102 via a suitable communications link 108. As will be appreciated by the skilled artisan, a suitable communications links 108 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art.

The system 100 depicted in FIG. 1 further includes a key server 110, communicatively coupled to the computer network 102 via a communications link 112. As will be understood by those skilled in the art, the key server 110 is any hardware, software, or combination thereof, suitably adapted to generate and store symmetric encryption keys, as well as associated user identification, such as a user ID or an electronic mail address. Any suitable means of generating symmetric keys known in the art are capable of being implemented by the key server 110 to generate symmetric encryption keys. The communications link 112 is any suitable data communications means known in the art, including, for example and without limitation, the public switched telephone network, a proprietary communications network, infrared, optical, 802.11a, 802.11b, 802.11g, 802.11(x), Bluetooth, WiMax, or any other suitable wire-based or wireless data transmission means known in the art. Preferably, the communications link 112 is suitably adapted to provide a secure communications channel between the key server 110 and any other electronic device coupled to the network 102, as will be understood by those skilled in the art. Accordingly, the subject application employs a Secure Socket Layer protocol for data security, however the skilled artisan will appreciate that any other suitable web security protocol known in the art is equally capable of being employed in accordance with the subject application.

As shown in FIG. 1, the system 100 also employs an authentication server 114, communicatively coupled to the computer network 102 via a communications link 116. The skilled artisan will appreciate that the authentication server 114 is any software, hardware, or combination thereof, suitably adapted to provide authentication services to the computer network 102. Preferably, the authentication server 114 advantageously provides verification of user identities, rights, passwords and the like. As will be understood by those skilled in the art, the authentication server 114 is capable of employing any verification and authentication methods, known in the art. The communications link 116 is any suitable means of data communication known in the art, including, for example and without limitation, infrared, optical, a proprietary communications network, the public switched telephone network, Bluetooth, WiMax, 802.11a, 802.11b, 802.11g, or 802.11(x), or any other suitable wire-based or wireless data transmission means known in the art. In the preferred embodiment of the subject application, the communications link 116 is suitably adapted to provide a secure communications channel between the authentication server 114 and any other electronic device coupled to the computer network 102, as will be appreciated by those skilled in the art. Preferably, the communications link 116, so as to ensure the security of the user authentication information that is verified by the authentication server 114, is implemented using data security protocols, such as Secure Socket Layer protocol, and the like. Those skilled in the art will appreciate that other web security protocols, as are known in the art, are capable of being implemented in accordance with the subject application.

As FIG. 1 depicts, the system 100 further incorporates one or more document management servers 118. As will be understood by those skilled in the art, the document management server 118 is any hardware, software, or suitable combination thereof capable of managing and storing electronic document data. Preferably, the document management server 118 includes mass storage capable of storing a plurality of electronic documents, including users and electronic mail addresses associated therewith. The skilled artisan will appreciate that the illustration of a document management server 118 as a stand-alone component is for illustration purposes only. Thus, those skilled in the art will understand that the document management server 118 is capable of being implemented as an application on the data storage device 106 communicatively coupled to the document processing device 104. The document management server 118 is communicatively coupled to the computer network 102 via a suitable communications link 120. As will be appreciated by those skilled in the art, suitable communications links include, for example and without limitation, 802.11a, 802.11b, 802.11g, 802.11(x), optical, infrared, WiMax, Bluetooth, the public switched telephone network, a proprietary communications network, or any other suitable wired or wireless data transmission means known in the art. Preferably, the communications link 120 is suitably adapted to enable secure communication of electronic document data, as well as user authentication information, via the computer network 102. More preferably, when communicating user authentication information, the communications link 120 is capable of employing Secure Socket Layer security protocols, or other web security protocols, known in the art, to provide security to the transmission of such user information. In accordance with the preferred embodiment of the subject application, the document management server 118 further includes processing and memory means, as are known in the art, capable of providing decryption services upon receipt of an encryption key from the key server 110, as will be explained in greater detail below.

The system 100 illustrated in FIG. 1 further includes at least one client device 122. Preferably, the client device 122 is communicatively coupled to the computer network 102 via a suitable communications link 124. It will be appreciated by those skilled in the art that the client device 122 is depicted in FIG. 1 as a laptop computer for illustration purposes only. As the skilled artisan will understand, the client device 122 shown in FIG. 1 is representative of any personal computing device known in the art, including, for example and without limitation, a computer workstation, a personal computer, a personal data assistant, a web-enabled cellular telephone, a smart phone, or other web-enabled electronic device suitably capable of generating and/or transmitting electronic document data to a multifunctional peripheral device. The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. In the preferred embodiment, the client device 122 is suitably adapted to request access to an electronic document via the document management server 118. Preferably, the client device 122 also includes an electronic mail client suitably adapted to manage electronic mail transmissions and facilitate in the retrieval and decryption of electronic document data.

In operation, according to the preferred embodiment of the subject application, the document processing device 104 receives electronic document data via any suitable means known in the art. Preferably, the document processing device 104 generates electronic document data via a scanning component, which generates electronic image data from a hardcopy document. It will be understood by those skilled in the art that the document processing device 104 is capable of receiving electronic image data via other means, including for example and without limitation, from a portable storage device, from a network storage device, as an electronic mail attachment, facsimile, optical character recognition, and the like. Irrespective of the manner in which the document processing device 104 receives the electronic document data, an identifier is assigned to the document. The document processing device 104 then determines output type, i.e., document storage on the document management server 118, or electronic mail.

When the received electronic document data is to be stored, for example on the document management server 118, or the local storage device 106, a list of one or more user IDs corresponding to those users allowed to access the document is received by the document processing device 104. Preferably, this listing of user IDs is received from the user initiating the storage operation. As will be appreciated by those skilled in the art, the document processing device 104, via the local storage device 106, or via a directory, for example, LDAP directory on the authentication server, is used by the user to designate those user IDs in the list. The list of user IDs, along with the assigned identifier, is then transmitted, via a secure connection to the key server 110. The key server 110 then generates a random symmetric encryption key and associates this key with the document identifier and corresponding user IDs. The encryption key is then transmitted to the document processing device 104, whereupon it is used to encrypt the received electronic document data. Key server identification data is then associated with the encrypted document, whereupon the encrypted document with key server identification data is transmitted to the designated storage location, e.g., the document management server 118 for storage. In accordance with one aspect of the subject application, the key server identification data corresponds to the network location of the key server 110, such as a URL address, IP address, or the like. The document processing device 104 then deletes the encryption key from its local memory once the document has been transmitted to its designated storage location.

When the selected output type is, for example, electronic mail as an attachment, the user originating the request is prompted to input, or select, the electronic mail address of one or more intended recipients. The document identifier, along with the selected addresses, is then transmitted to the key server 110. The key server 110 then generates a random symmetric encryption key to be used by the document processing device 104 in the encryption of the electronic document prior to transmission to the designated addresses. The key server 110 then stores the encryption key, along with the document identifier and associated addresses prior to transmitting the key to the document processing device 104. The document processing device 104 then encrypts the electronic document data using the received encryption key. An electronic mail message, to the designated recipients, is then prepared, placing key server 110 identification data in the header portion of the message. The encrypted document is then attached to the message and the message is transmitted to the designated recipients. In accordance with one aspect of the subject application, the key server identification data corresponds to the network location of the key server 110, such as a URL address, IP address, or the like. The document processing device 104 then deletes the encryption key from its local memory once the electronic mail message has been transmitted to the designated recipients.

In order to decrypt the encrypted stored electronic document, or the encrypted document included in a received electronic mail message, a user logs onto the document processing device 104 via any suitable means. Preferably, the document processing device 104 receives user authentication information from the user that is logging onto the document processing device 104. It will be understood by those skilled in the art that suitable login means include, for example and without limitation, providing user ID and password combinations via the user-interface associated with the document processing device 104, by using a network logon via the client device 122, or any other means known in the art. The user then requests access to the encrypted document, i.e., requests that the document processing device 104 decrypts the selected document and display or otherwise dispose of the document. It will be understood by those skilled in the art that the process of logging on and requesting decryption is capable of being automatically implemented, i.e., transparently, when the document is received via an electronic mail message. That is, to access an electronic mail account, and the messages contained therein, a user is first prompted to provide authentication data. The client device 122 preferably employs an electronic mail client, or software application, suitable adapted to initiate the decryption request. Those skilled in the art will appreciate that as used hereinafter with respect to decryption, the functioning of the mail client resident on the client device 122 mirrors that of the document processing device 104 such that those actions described as being performed by the document processing device 104 are capable of being performed by the mail client, without requiring the client device 122 to interact with the document processing device 104.

Irrespective of the manner in which the user authentication information is received, or the access/decryption request is initiated, the document processing device 104 transmits the user authentication information, along with the document identifier associated with the selected document to the key server 110, thereby requesting the encryption key to be used in decrypting the selected document. Those skilled in the art will appreciate that the user information includes, for example and without limitation, a user ID or electronic mail address, or the like. The key server 110 then determines whether or not the user ID or electronic mail address contained in the received user information is associated with the received document identifier. When the key server 110 determines that the user ID or electronic mail address received is not associated with the received document identifier, an error message is returned to the document processing device 104, or the mail client, thereby denying access to a decrypted form of the selected document.

When the key server 110 determines that the user ID or electronic mail address is associated with the received document identifier, the key server 110 requests that the authentication server 114 verifies the authentication information received from the document processing device 104 of the mail client. That is, the authentication server 114 verifies that the login data provided by the user is authentic, e.g., the user ID and password match those of record. An invalid result returns an error message to the document processing device 104 or the mail client, whereas a positive result returns verification to the key server 110. The key server 110 then transmits the encryption key, which is associated with the document identifier, to the requesting document processing device 104 or mail client. In the case of the request originating from the document processing device 104, the document processing device 104 retrieves the encrypted document from the document management server 118 and decrypts the document using the received encryption key, thereby allowing further document processing operations in accordance with the user's selections. In the case of the mail client, the received encryption key is used to decrypt the document attached in the electronic mail message, thereby allowing the user to view the decrypted document and perform subsequent actions on the document.

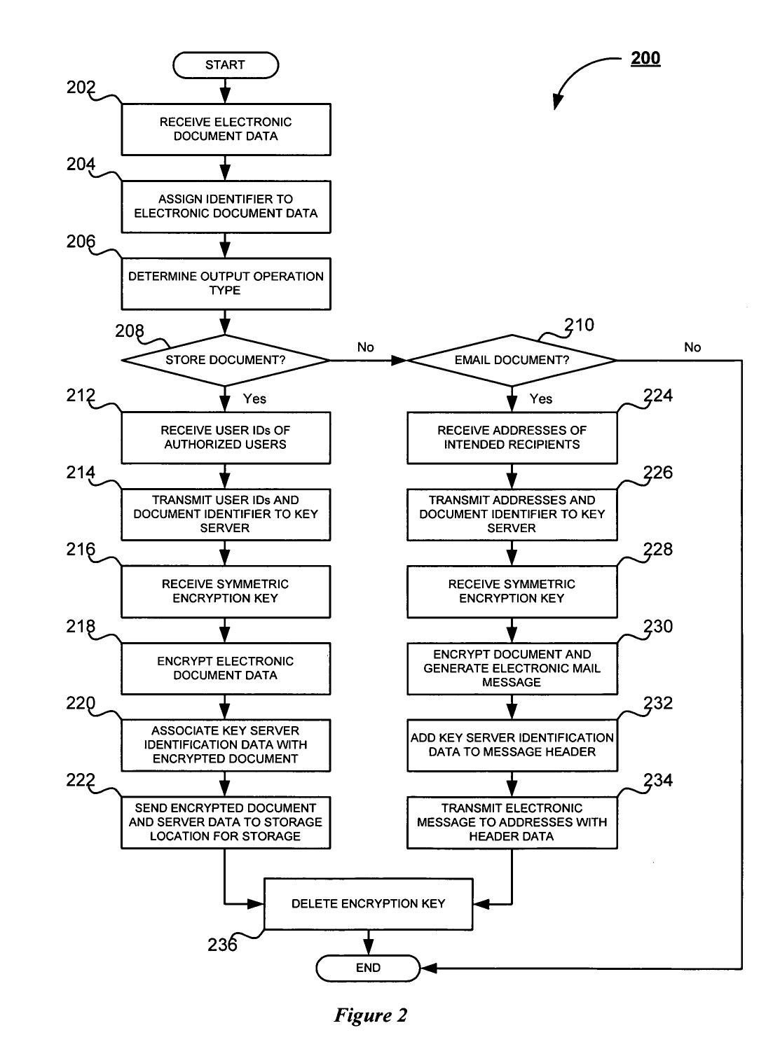

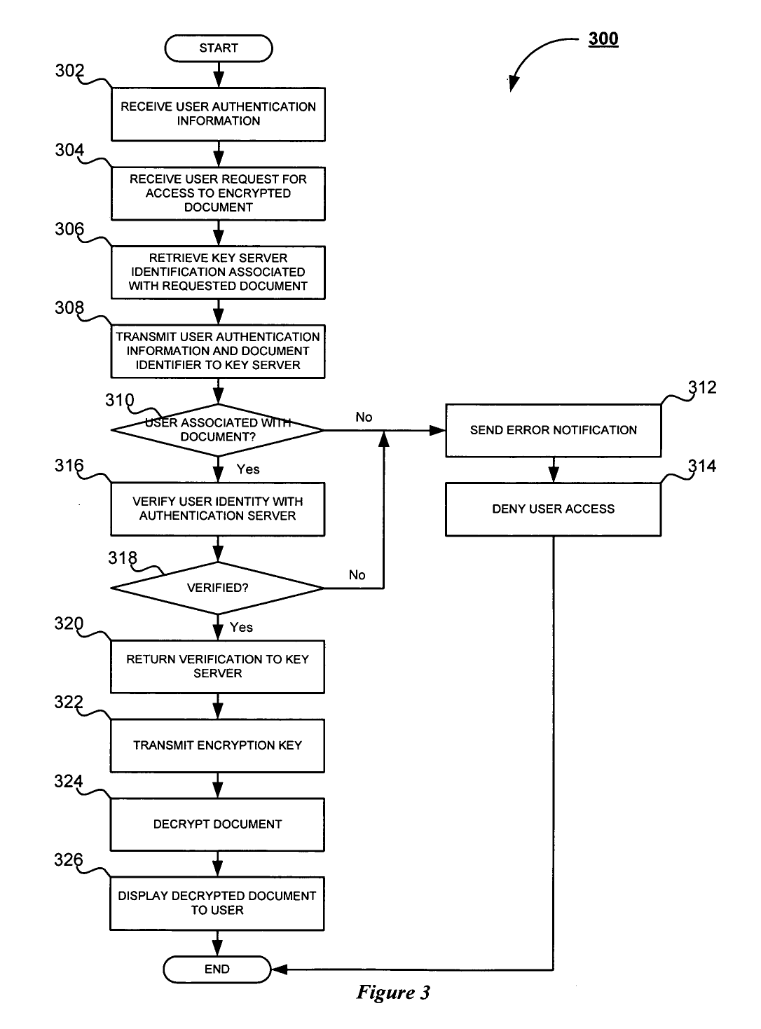

The foregoing system 100 will better be understood when viewed in conjunction with the methodologies illustrated in FIG. 2 and FIG. 3. Referring now to FIG. 2, there is shown a flowchart 200 illustrating a method for secure handling of scanned documents from an encryption view in accordance with the subject application. Beginning at step 202, a document processing device 104 receives electronic document data via any suitable means known in the art including, for example and without limitation, as the result of a scanning operation performed by the document processing device 104. At step 204, the document processing device 104 assigns a unique identifier to the electronic document and determines, at step 206, the output operation selected by the user. It will be appreciated by those skilled in the art that the use of the storage and electronic mail operations is for example purposes only and the subject methodology is not limited solely to these operations, but rather is capable of application to any document processing operation as is known in the art.

A determination is then made at step 208 whether the selected operation is a storage of an electronic document operation. A positive determination at step 208 prompts the document processing device 104 to retrieve, from the originator of the document processing request associated with the electronic document data, one or more user IDs corresponding to those users who are to have access to the electronic document data at step 212. Preferably, the user IDs are input by the user via the associated user-interface, or are selected from a list of user IDs to which the document processing device 104 has access. The one or more user IDs, along with the document identifier, are then transmitted to the key server 110 at step 214, thereby requesting an encryption key to be used in encrypting the electronic document data. The key server 110 then generates a random symmetric encryption key via any suitable means known in the art and sends the key to the document processing device 104 at step 216. Preferably, the key server 110 stores the key and the corresponding document identifier and user IDs locally for access during decryption, as will be explained in greater detail below. The document processing device 104 then encrypts the electronic document at step 218 using the received encryption key. The encrypted electronic document is then associated with key server 110 identification data, representative of the location and identification of the key server that provided the original encryption key, at step 220. The encrypted document and associated key server identification data are then transmitted to the document management server 118, the local storage device 106, or other storage location at step 222, whereupon the encrypted document and associated data is stored for later access. The document processing device 104 then deletes the received encryption key at step 236, whereupon the operation ends.

Returning to step 208, when the selected operation is not a storage operation, flow proceeds to step 210, whereupon a determination is made whether the selected operation is an electronic mail operation. When the selected operation is not an electronic mail operation, the method terminates. When the selected operation is the transmission of the electronic document data as an attachment or other part of an electronic mail message, flow proceeds to step 224. At step 224, the originator of the electronic mail request is prompted to provide the electronic mail addresses of one or more intended recipients. It will be appreciated by those skilled in the art that these addresses are capable of being input via the associated user-interface. It will further be understood that the addresses are capable of being input manually by a user, or selected from a directory or listing of such addresses stored either locally on the local storage device 106, or another network location, such as a directory server (not shown).

Irrespective of the method in which the electronic mail addresses are selected or input by the requesting user, flow proceeds to step 226, whereupon the addresses and document identifier are transmitted to the key server 110. The key server 110 then generates a symmetric encryption key via any suitable means known in the art and sends the key to the requesting document processing device 104 at step 228. Preferably, the key server 110 stores the generated encryption key, associated document identifier and addresses locally for further access during decryption operations, as set forth in FIG. 3. The document processing device 104 then encrypts the electronic document data using the received encryption key at step 230 and generates an electronic mail message containing the encrypted document as an attachment or other portion of the message at step 230. At step 232, the document processing device 104 adds key server 110 identification data to the header portion of the electronic mail message. Preferably, such data includes, but is not limited to, a URL or other network location identifier, as are known in the art. The electronic mail message is then transmitted to the selected addresses at step 234. Following transmission of the electronic mail message, inclusive of the encrypted document, flow proceeds to step 236, whereupon the document processing device 104 deletes the received encryption key.

Having thus described the methodology whereby a document is encrypted in accordance with the subject application, discussion now turns to the decryption side of the method embodied by the subject application. Turning now to FIG. 3, there is shown a flowchart 300 illustrating a method for secure handling of scanned documents from a decryption view in accordance with the subject application. Beginning at step 302, user authentication information is received, in conjunction with a request to access a desired document. As stated above, the user authentication information is capable of being received from a user via the associated user-interface of the document processing device 104, or alternatively, from an electronic mail client, such as that operating on the client device 122. As the skilled artisan will appreciate, the receipt of user authentication information at the document processing device 104 corresponds to a request to access a document stored on the document management server 118 or other storage location, whereas receipt of user authentication information from an electronic mail client corresponds to a request for decryption of a document received by the client device 122 as an electronic mail attachment. In the preferred embodiment, the user authentication information includes a document identifier, key server identification data, user ID, electronic mail address, and the like.

At step 304, a user associated with the user authentication information requests access to an encrypted electronic document, as determined by the document identifier accompanying such request. It will be understood by those skilled in the art, as explained above, that steps 302 and 304 are combined when the request is issued by the electronic mail client. At step 306, the key server 110 identity is ascertained from the key server identification data. Once the key server 110 has been identified, the user authentication information, along with the document identifier, is transmitted to the key server 110 at step 308. At step 310, the key server 110 determines whether the user ID or address received is associated with the document identifier received. When no such association is found, flow proceeds to step 312, whereupon an error message is returned to the requesting document processing device 104 or electronic mail client. Thereafter, the requesting party is denied access at step 314 and the operation terminates.

When an association is found by the key server 110 at step 310, flow proceeds to step 316 for verification of the user associated with the user ID or address with the transmission of the user authentication information to the authentication server 114. The authentication server 114 then determines, at step 318, whether the user is verified. When verification is unsuccessful, flow proceeds to step 312, whereupon an error notification is returned to the requesting document processing device 104 or mail client. It will be appreciated by those skilled in the art that while the instant description uses the key server 110 for the initial authentication, the subject application is not so limited. For example, the document processing device 104 is capable of receiving a user ID/password combination from the user associated with the client device 122 and verifying such identification information with the authentication server 114. Once validity is established, the document processing device 104 then requests the key server 110 to provide the symmetric key for the validated user. Thereafter, the key server 110 performs the second round of validation by determining if the user is associated with the document identifier and determining the validity of the symmetric key proffered by the associated user.

The requested access is then denied at step 314. When verification is successful at step 318, e.g., the user authentication information matches previously stored user authentication information, flow proceeds to step 320, whereupon a verification notification is returned to the key server 110 from the authentication server 114. The key server 110 then locates, in local storage, the encryption key associated with the document identifier at step 322 and transmits the key to the requesting document processing device 104 or mail client. The requesting document processing device 104 or mail client then decrypts the document at step 324. It will be appreciated by those skilled in the art that step 324 for the document processing device 104 includes the retrieval, from storage, of the document designated by the document identifier. The decrypted electronic document is then displayed to the user at step 326 for further document processing operations.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for secure handling of scanned documents comprising:
receiving means adapted for receiving electronic document data representative of content of at least one tangible document from an associated scanner;
means adapted for assigning document identifier data to each received electronic document;
a key server including
data storage including means adapted for storing key data representative of a plurality of encryption keys, each encryption key being associated with document identifier data corresponding thereto, and
means adapted for communicating with an associated data network;
encryption means adapted for encrypting received electronic document data in accordance with at least one encryption key;
means adapted for communicating encrypted electronic document data to at least one destination;
means adapted for receiving user information from an associated user, which user information includes identification data corresponding to the associated user;
means adapted for receiving, from the associated user, a document access request directed to at least one selected electronic document, which document access request includes data representative of a desired access to at least one encrypted electronic document;
means adapted for communicating user information and document identifier data corresponding to the at least one selected electronic document to the key server;
testing means adapted for testing the user information to determine accessibility of the at least one selected electronic document in accordance with the user information; and
means adapted for selectively decrypting the at least one selected electronic document in accordance with key data corresponding thereto.

2. The system for secure handling of scanned documents of claim 1 wherein the associated scanner is comprised of a facsimile input.

3. The system for secure handling of scanned documents of claim 1 wherein the associated scanner is comprised of an optical character recognition device.

4. The system for secure handling of scanned documents of claim 1 wherein the associated scanner is comprised of a digitizing image scanner.

5. The system for secure handling of scanned documents of claim 1 wherein the at least one destination is a data storage.

6. The system for secure handling of scanned documents of claim 1 wherein the at least one destination is an electronic mail to at least one selected recipient.

7. A method for secure handling of scanned documents comprising the steps of:
receiving electronic document data representative of content of at least one tangible document from an associated scanner;
assigning document identifier data to each received electronic document;
storing key data representative of a plurality of encryption keys in an associated key server, each encryption key being associated with document identifier data corresponding thereto;
encrypting received electronic document data in accordance with at least one encryption key;
communicating encrypted electronic document data to at least one destination;
receiving user information from an associated user, which user information includes identification data corresponding to the associated user;
receiving, from the associated user, a document access request directed to at least one selected electronic document, which document access request includes data representative of a desired access to at least one encrypted electronic document;
communicating user information and document identifier data corresponding to the at least one selected electronic document to the key server;
testing the user information to determine accessibility of the at least one selected electronic document in accordance with the user information; and
selectively decrypting the at least one selected electronic document in accordance with key data corresponding thereto.

8. The method for secure handling of scanned documents of claim 7 wherein the electronic document is received via facsimile input.

9. The method for secure handling of scanned documents of claim 7 wherein the electronic document is received via optical character recognition device.

10. The method for secure handling of scanned documents of claim 7 wherein the electronic document is received via digitizing image scanner.

11. The method for secure handling of scanned documents of claim 7 wherein the encrypted electronic document is communicated to a data storage.

12. The method for secure handling of scanned documents of claim 7 wherein the encrypted electronic document is communicated as an electronic mail to at least one selected recipient.

13. A computer-implemented method for secure handling of scanned documents comprising the steps of:
receiving electronic document data representative of content of at least one tangible document from an associated scanner;
assigning document identifier data to each received electronic document;
storing key data representative of a plurality of encryption keys in an associated key server, each encryption key being associated with document identifier data corresponding thereto;
encrypting received electronic document data in accordance with at least one encryption key;
communicating encrypted electronic document data to at least one destination;
receiving user information from an associated user, which user information includes identification data corresponding to the associated user;
receiving, from the associated user, a document access request directed to at least one selected electronic document, which document access request includes data representative of a desired access to at least one encrypted electronic document;
communicating user information and document identifier data corresponding to the at least one selected electronic document to the key server;
testing the user information to determine accessibility of the at least one selected electronic document in accordance with the user information; and
selectively decrypting the at least one selected electronic document in accordance with key data corresponding thereto.

14. The computer-implemented method for secure handling of scanned documents of claim 13 wherein the electronic document is received via facsimile input.

15. The computer-implemented method for secure handling of scanned documents of claim 13 wherein the electronic document is received via optical character recognition device.

16. The computer-implemented method for secure handling of scanned documents of claim 13 wherein the electronic document is received via digitizing image scanner.

17. The computer-implemented method for secure handling of scanned documents of claim 13 wherein the encrypted electronic document is communicated to a data storage.

18. The computer-implemented method for secure handling of scanned documents of claim 13 wherein the encrypted electronic document is communicated as an electronic mail to at least one selected recipient.
